(19) United States
(12) Patent Application Publication
(10) Pub. No.: US 2012/0217121 A1
(43) Pub. Date: Aug. 30, 2012

(54) HYBRID DRIVE APPARATUS

(75) Inventors: Kazuyuki NODA, Anjo (JP); Keiji SUZUKI, Anjo (JP)

(73) Assignee: AISIN AW CO., LTD., Anjo-shi (JP)

(21) Appl. No.: 13/372,898

(22) Filed: Feb. 14, 2012

(30) Foreign Application Priority Data
Feb. 28, 2011 (JP) 2011-043382

(51) Int. Cl. F16D 13/72

(52) U.S. Cl. 192/113.3

(57) ABSTRACT

A hybrid drive apparatus includes a case with first and second friction plates that can be soaked with oil. A communication mechanism allows or cuts off the communication between an internal space of the case and outside, and discharges the to the outside when the internal space communicates with the outside. A controller controls an engagement pressure to obtain a disengaged state in which the first and second friction plates are disengaged and a slipping state in which the first and second friction plates slip and rotate. An oil adjustment portion adjusts an oil amount supplied to the internal space, based on a control state of the friction engagement device, and adjusts the oil amount to a first amount when the friction engagement device is disengaged, and adjusts the oil amount to a second amount larger than the first amount when the friction engagement device starts to slip.

### INCORPORATION BY REFERENCE

The disclosure of Japanese Patent Application No. 2011-043382 filed on Feb. 28, 2011 including the specification, drawings and abstract is incorporated herein by reference in its entirety.

### BACKGROUND OF THE INVENTION

The present invention relates to hybrid drive apparatuses including a friction engagement device placed on a transmission path between an engine and wheels.

1. Description of the Related Art

In recent years, hybrid cars including a rotating electrical machine in addition to an engine as driving sources have been actively studied due to increasing environmental awareness. Since such a hybrid car has a rotating electrical machine as a driving source as described above, the hybrid car not only runs by the engine, but also regenerates kinetic energy of the vehicle by the rotating electrical machine, and runs only by the rotating electrical machine without using the engine (EV running), in order to improve energy efficiency.

However, such a hybrid car has the following problem. If the engine is connected to the drive system even during EV running during which the engine is not used, drag torque is increased due to dragging of the engine.

As a solution to this problem, there are hybrid drive apparatuses that include a clutch capable of allowing and interrupting power transmission between the engine and the rotating electrical machine, and that disengages the clutch during EV running to prevent dragging of the engine.

However, such a clutch capable of allowing and interrupting power transmission from the engine may transmit power while causing the clutch to slip, such as when the vehicle is started by the engine, Thus, in hybrid drive apparatuses described in Japanese Patent Application Publication No. JP-A-2010-196868, it has been proposed to accommodate the clutch in a fluid-tight housing so that the clutch can be sufficiently cooled even when the clutch generates a large amount of heat.

### SUMMARY OF THE INVENTION

However, in this case, if EV running is conducted with the clutch being placed in the fluid-tight state, the rotation difference is generated between the fluid-tight housing and friction plates on the side of the rotating electrical machine or on the engine side, because the clutch is in the disengaged state. Thus, stirring resistance is generated due to the relative rotation between the housing and the friction plates, whereby drag torque is increased.

There is need for a hybrid drive apparatus that ensures capability of cooling a clutch capable of disconnecting an engine from a drive system while reducing the drag torque during EV running. This need is met by a hybrid drive apparatus according to an aspect of the present invention. A hybrid drive apparatus according to the aspect of the present invention includes: a friction engagement device placed on a transmission path between an engine and a wheel and having a first friction plate drivingly coupled to a transmission path on an engine side in the transmission path and a second friction plate drivingly coupled to a transmission path on a wheel side, a rotating electrical machine drivingly coupled to the transmission path on the wheel side; a case member having an internal space that accommodates the first and second friction plates of the friction engagement device and that is configured so that the first and second friction plates can be soaked with oil; a communication mechanism that is capable of allowing or cutting of the communication between the internal space of the case member and outside, and that discharges the oil from the internal space to the outside when the internal space communicates with the outside; a friction engagement device control portion in which the friction engagement device is capable of controlling an engagement pressure to obtain a disengaged state in which the first and second friction plates are disengaged and a slipping state in which the first and second friction plates slip and rotate; and an oil amount adjustment portion that is configured to be able to adjust an oil amount to be supplied to the internal space of the case member, based on a control state of the friction engagement device, and that adjusts the oil amount to a first supply oil amount when the friction engagement device is disengaged, and adjusts the oil amount to a second supply oil amount larger than the first supply oil amount when the friction engagement device starts to slip.

Thus, the filling state of the case member with the oil is switched by the communication mechanism. Accordingly, in the case where the friction engagement device generates a large amount of heat, the case member is filled with the oil to ensure the capability of cooling the friction engagement device. Moreover, in the case where the vehicle runs with the friction engagement device being disengaged, such as during EV running, the oil is discharged from the case member to reduce the stirring resistance of the oil generated by the friction plates, whereby the drag torque of the hybrid drive apparatus can be reduced.

Moreover, since the second supply oil amount that is supplied to the internal space of the case member when the friction engagement device starts to slip is made larger than the first supply oil amount that is supplied to the internal space of the case member when the friction engagement device is disengaged, a large amount of oil can be supplied to the internal space of the case member in the slipping state in which the friction plates slip and rotate and the friction engagement device generates heat. Accordingly, the friction engagement device can be effectively cooled. Even if the inside of the case member is empty when the friction engagement device starts to slip, the oil is supplied to the internal space of the case member by the second supply oil amount larger than the first supply oil amount, and thus the internal space of the case member can be rapidly filled with the oil.

### BRIEF DESCRIPTION OF THE DRAWINGS

FIG. 1 is a schematic diagram showing a hybrid car according to a first embodiment of the present invention;

FIG. 2 is a schematic diagram showing an input portion of the hybrid drive apparatus according to the first embodiment of the present invention;

FIG. 3 is a hydraulic circuit diagram showing a control valve according to the first embodiment of the present invention;

FIG. 4 is a timing chart showing the state of circulating oil in a clutch housing according to the first embodiment of the present invention;

FIG. 5 is a hydraulic circuit diagram showing a control valve according to a second embodiment of the present invention;

FIG. 6 shows schematic diagrams showing a switch valve of the control valve in FIG. 5;

FIG. 7 is a hydraulic circuit diagram showing a control valve according to a third embodiment of the present invention;

FIG. 8 is a timing chart showing the state of circulating oil in a clutch housing according to the third embodiment of the present invention;

FIG. 9 is a flowchart showing the state of the circulating oil in the clutch housing according to the third embodiment of the present invention; and

FIG. 10 is a flowchart showing a modification of the timing chart in FIG. 8.

### DETAILED DESCRIPTION OF THE EMBODIMENTS

Vehicle drive apparatuses according to embodiments of the present invention will be described below with reference to the accompanying drawings. Note that hybrid drive apparatuses as the vehicle drive apparatuses according to the embodiments of the present invention are preferably mounted on front engine front drive (FF) vehicles, and the left-right direction in the figures corresponds to the left-right direction in the state in which the hybrid drive apparatus is actually mounted on a vehicle. For convenience of description, a side where a driving source such as an engine is located is herein referred to as the “front side,” and the opposite side from the side where the driving source is located is referred to as the “rear side.” As used herein, the expression “drivingly coupled” refers to the state in which two rotating elements are coupled together so that a driving force can be transmitted therebetween, and is used as a concept including the state in which the two rotating elements are coupled together so as to rotate together, or the state in which the two rotating elements are coupled together so that the driving force can be transmitted therebetween via one or more transmission members. Such transmission includes various members that transmit rotation at the same speed or at a shifted speed, and include, e.g., a shaft, a gear mechanism, a belt, a chain, etc.

### First Embodiment

[Schematic Configuration of Hybrid Drive Apparatus]

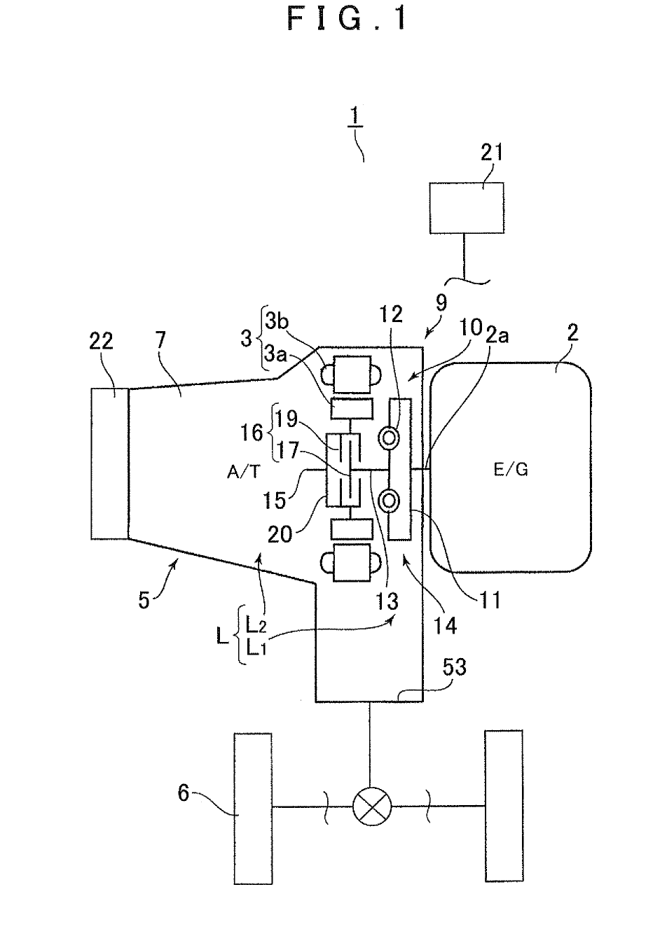

As shown in FIG. 1, a hybrid car 1 has, as driving sources, a rotating electrical machine (a motor generator) 3 in addition to an engine 2, and a hybrid drive apparatus 5 forming a power train of the hybrid car 1 is configured to include a transmission device 7 provided on a transmission path L between the engine 2 and wheels 6, and an input portion 9 placed between the transmission device 7 and the engine 2 to receive power from the engine 2.

The input portion 9 is formed by providing with the rotating electrical machine 3 a power transmission device 10 that transmits power between the engine 2 and the transmission device 7. This power transmission device 10 is formed by a connection portion 14 having a damper 12 that is connected to a crankshaft 2a of the engine 2 via a drive plate 11 and a connection shaft 13 on which the damper 12 is spline fitted, and a clutch (a friction engagement device) 16 that allows and interrupts power transmission between the connection portion 14 and an input shaft (an input portion) 15 of the transmission device 7.

The clutch 16 is formed by a multi-plate clutch having both a plurality of inner friction plates (first friction plates) 17 and a plurality of outer friction plates (second friction plates) 19 accommodated in an internal space S of a clutch housing 20, and this clutch housing 20 is coupled so as to rotate together with the input shaft 15 of the transmission device 7. That is, the clutch 16 has the inner friction plates 17 that are drivingly coupled to a transmission path L₁ on the engine side in the transmission path L, and the outer friction plates 19 that are drivingly coupled to a transmission path L₂ on the wheel side in the transmission path L, and the clutch housing 20 is also drivingly coupled to the transmission path on the wheel side.

Moreover, the rotating electrical machine 3 is positioned radially outside of the outer diameter of the clutch housing 20 so as to overlap the clutch 16 in the axial direction. This rotating electrical machine 3 is configured so that a stator 3b is positioned radially outside a rotor 3a fixedly provided on the clutch housing 20 so as to face the rotor 3a.

That is, in the hybrid drive apparatus 5, the connection portion 14, the clutch 16, the rotating electrical machine 3, and the transmission device 7 are sequentially arranged from the engine side toward the wheel side. In the case where both the engine 2 and the rotating electrical machine 3 are driven to cause the vehicle to run, a control valve (a hydraulic control device) 22 of the hybrid drive apparatus 5 is controlled by a control portion 21 to engage the clutch 16, During EV running during which the vehicle runs only by the driving force of the rotating electrical machine 3 drivingly coupled to the transmission path L₂ on the wheel side, the clutch 16 is disengaged to disconnect the transmission path L₁ on the engine side from the transmission path L₂ on the wheel side.

[Configuration of Input Portion]

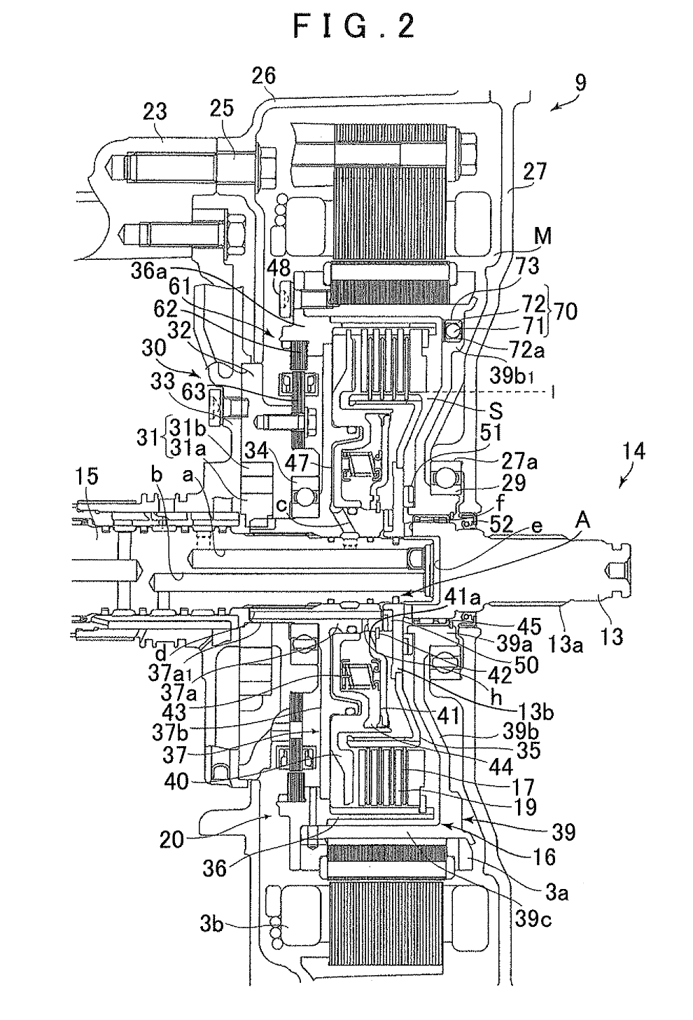

The configuration of the input portion 9 will be described in detail below. As shown in FIG. 2, the clutch 16 and the rotating electrical machine 3 are accommodated in a motor housing (a housing) 26 fixed by a bolt 25 to a transmission case 23 accommodating the transmission device 7. A space inside the motor housing 26 accommodating the clutch 16 and the rotating electrical machine 3 is separated by a partition wall 27 integrally attached to the motor housing 26 from a portion to which the engine 2 is attached.

The connection shaft 13 that is connected to the engine 2 via the damper 12, and the input shaft 15 of the transmission device 7 are fittingly inserted through the central portion of the motor housing 26 so that the central axis of the connection shaft 13 matches that of the input shaft 15. This connection shaft 13 is rotatably supported by a ball bearing 29 provided in a cylindrical portion 27a of the partition wall 27.

On the other hand, the input shaft 15 is rotatably supported by a ball bearing 34 provided in an oil pump body 32 fixed to the transmission case 23 via an oil pump cover 33.

Note that an oil pump 30 having the oil pump body 32 is provided on the transmission device side with respect to the clutch 16, and is formed by an oil pump gear (a rotor) 31 formed by a drive gear 31a and a driven gear 31b, the oil pump body 32 accommodating the oil pump gear 31, and the oil pump cover 33 that is attached to the oil pump body 32 from the transmission device side.

A spline portion 13a of the connection shaft 13, on which the damper 12 is spline fitted, protrudes from the partition wall 27, and an end of the connection shaft 13, which is located on the transmission device side in the motor housing 26, extends toward the radial outer side to form a flange portion 13b. A clutch hub 35 of the clutch 16 is attached to the flange portion 13b.

The clutch hub 35 is a part forming the clutch 16 that allows and interrupts power transmission between the connection shaft 13 to which power from the engine 2 is transmitted, and the input shaft 15 of the transmission device 7. The clutch hub 35 extends so as to face a clutch drum 36 that is drivingly coupled to the input shaft 15 via the clutch housing 20.

More specifically, the clutch drum 36 extends in the axial direction from an end radially outward of a rear wall portion 37b of the clutch housing 20 toward a front wall portion 39b, and is provided so that the inner peripheral surface of the clutch drum 36 located radially outward faces the outer peripheral surface of the clutch hub 35 located radially inward. The plurality of outer friction plates 19, which are comprised of annular friction plates and which, on the outer peripheral side of the outer friction plates 19, spline engage with the inner peripheral surface of the clutch drum 36, are provided on the inner peripheral surface of the clutch drum 36. The plurality of inner friction plates 17, which are comprised of annular friction plates and which, on the inner peripheral side of the inner friction plates 17, spline engage with the inner peripheral surface of the clutch hub 35, are provided on the outer peripheral surface of the clutch hub 35, so that the outer friction plates 19 and the inner friction plates 17 are alternately arranged.

Moreover, the clutch 16 has a piston 40 that forms a hydraulic oil chamber 47 between the piston 40 and the rear wall portion 37b, a spring retainer 41 that is retained on a boss portion 37a of the rear wall portion 37b by a snap ring 42, and a return spring 43 that is provided in a compressed state between the piston 40 and the spring retainer 41. The piston 40 presses the outer friction plates 19 and the inner friction plates 17, whereby the clutch 16 is engaged.

That is, the inner friction plates 17 are drivingly coupled so as to rotate together with the connection portion 14 to which power from the engine 2 is applied via the connection shaft 13, and the outer friction plates 19 are drivingly coupled to the input shaft 15 of the transmission device 7 via the rear wall portion 37b of the clutch housing 20. The clutch 16 is a starting clutch that allows and interrupts power transmission from the engine 2 to the transmission device 7 by engaging and disengaging the inner friction plates 17 with and from the outer friction plates 19.

Note that a space portion facing the hydraulic oil chamber 47 with the piston 40 interposed therebetween, that is, the space formed by the piston 40 and the spring retainer 41, is a cancel oil chamber 44 that cancels a centrifugal oil pressure that is generated in the hydraulic oil chamber 47.

The clutch housing 20 described above is a case that divides the space inside the motor housing 26, which accommodates the clutch housing 20 accommodating the clutch 16, into the internal space S accommodating the inner friction plates 17 and the outer friction plates 19 and an external space (outside) M accommodating the rotating electrical machine 3. This internal space S is configured to be able to be filled with oil without leaking circulating oil (oil).

That is, the clutch housing 20 is integrally formed by the front wall portion (the sidewall on the engine side) 39b provided on the engine side with respect to the clutch 16 so as to extend toward the radial outer side, the rear wall portion (the sidewall on the transmission side) 37b provided on the transmission device side with respect to the clutch 16 so as to extend toward the radial outer side, and an annular portion 39c connecting the front wall portion 39b and the rear wall portion 37b to form the peripheral surface of the clutch housing 20.

Individual components of the clutch housing 20 will be described below. The front wall portion 39b and the annular portion 39c described above are formed by a cylindrical case member 39, and a boss portion 39a of the case member 39 is relatively rotatably fitted on the connection shaft 13 via a needle bearing 45. Moreover, since the boss portion 39a is interposed between the connection shaft 13 and the ball bearing 29, one end of the clutch housing 20 is rotatably supported by the partition wall 27 via the ball bearing 29.

On the other hand, the rear wall portion 37b of the clutch housing 20 is formed by a plate-like member 37 and the clutch drum 36, and this plate-like member 37 is formed by the wall portion 37b extending toward the radial outer side and the boss portion 37a extending both forward and rearward along the axial direction from the wall portion 37b.

A portion on the transmission device side in the boss portion 37a is a shaft portion 37a₁ having splines formed on its inner peripheral surface, and is spline fitted on the input shaft 15. Moreover, since this shaft portion 37a₁ is interposed between the ball bearing 34 and the input shaft 15, the other end of the clutch housing 20 is rotatably supported by the oil pump body 32 serving as a fixing member via the ball bearing 34.

Note that since the driving force from the engine 2 and the driving force from the rotating electrical machine 3 can be applied to the shaft portion 37a₁, the shaft portion 37a₁ serves also as a drive shaft of the oil pump 30. A key way formed in the tip end of the shaft portion 37a₁ is fitted on a key formed radially inward of the drive gear 31a of the oil pump 30, whereby the shaft portion 37a₁ is drivingly coupled to the oil pump 30.

Thus, the clutch housing 20 serves as a case member accommodating the clutch 16, and as described above, serves also as a support member that covers the clutch 16 and is stably supported by the both-end support structure by the front wall portion 39b and the rear wall portion 37b. That is, the clutch housing 20 is stably supported in the radial and axial directions on both sides of the clutch 16 in the axial direction via the ball bearings (bearing members) 29, 34.

Thus, the outer peripheral surface of the annular portion 39c is an attachment portion to which the rotor 3a of the rotating electrical machine 3 is attached, and is configured so that the rotor 3a can be fixedly provided by a bolt 48.

The stator 3b, which is provided radially outside of the rotor 3a, is fixedly provided in the motor housing 26 so as to face the rotor 3a. The rotating electrical machine 3 is formed by the rotor 3a and the stator 3b.

Moreover, a rotor (an exciting coil) 62 of a resolver 61 that detects rotation of the rotating electrical machine 3 is attached to an end 36a on the transmission device side in the clutch drum 36, which forms together with the annular portion 39c the attachment portion. A stator (a detecting coil) 63 is fixedly provided on the oil pump body 32 located radially inward of the rotor 62.

Note that although the clutch housing 20 is supported in the axial and radial directions by the ball bearings 29, 34, the clutch housing 20 may be supported in the radial direction by a needle bearing, and supported in the axial direction by a thrust bearing.

[Oil Passage Configuration]The oil passage configuration of the input portion 9 will be described below. A plurality of oil passages “a,” “b,” to which an oil pressure regulated by a control valve 22 is supplied, are formed in the input shaft 15 of the transmission device 7, and a control pressure of the clutch 16 is supplied to the oil passage “a.”

An oil passage “c” connecting to the hydraulic oil chamber 47 of the clutch 16 is formed in the boss potion 37a of the rear wall portion 37b of the clutch housing 20, and a hydraulic servo 56 of the clutch 16 is formed by the oil passages “a,” “c,” the hydraulic chamber 47, etc.

Moreover, an oil passage “d,” to which the circulating oil (oil) supplied to the internal space S of the clutch housing 20 to cool the clutch is supplied, is formed along the input shaft 15 in the boss portion 37a of the rear wall portion 37b. An oil supply portion A, which supplies the circulating oil to the internal space S of the clutch housing 20, is formed by the oil pump 30 that generates an oil pressure, and a supply oil passage including the oil passage “d” to which the circulating oil is supplied, and guiding the oil discharged from the oil pump 30 into the internal space S of the clutch housing 20. The oil passage “d” serving as a supply oil passage for the circulating oil connects to the internal space S of the clutch housing 20 through a gap held by a thrust bearing 50 interposed between the flange portion 13b of the connection shaft 13 and the boss portion 37a of the rear wall portion 37b.

The oil passage “b” of the input shaft 15 is a discharge oil passage that discharges the circulating oil from the internal space S of the clutch housing 20. This oil passage “b” connects to the internal space S of the clutch housing 20 through an oil passage “f” provided in the connection shaft 13 and a gap “e” between the input shaft 15 and the connection shaft 13.

Thus, the circulating oil supplied from the oil passage “d” to the internal space S flows through a gap among the thrust bearing 50, the spring retainer 41 and the clutch hub 35, and cools the inner friction plates 17 and the outer friction plates 19 from the radial inner side of the clutch 16. The circulating oil that has cooled the friction plates 17, 19 of the clutch 16 flows through a gap between the front wall portion 39b and the clutch hub 35 and a gap between the flange portion 13b and the front wall portion 39b of the clutch housing 20, which are held by a thrust bearing 51, and is discharged from an oil passage “f” located on the opposite side of the clutch hub 35 from the passage that is used to supply the circulating oil.

Note that the circulating oil filling the internal space S flows through the gap between the connection shaft 13 and the boss portion 39a of the front wall portion 39b and the gap between the front wall portion 39b and the partition wall 27, and is discharged to the external space M of the clutch housing 20 while lubricating the needle bearing 45 and the ball bearing 29, and the circulating oil that has been discharged to the external space M returns to an oil pan 53 (see FIG. 1) provided downward of the motor housing 26.

Thus, the internal space S of the clutch housing 20, which accommodates the inner friction plates 17 and the outer friction plates 19, is configured to store the circulating oil that is supplied from the radial inner side through the supply oil passage “b” so that the inner friction plates 17 and the outer friction plates 19 can be soaked with the stored circulating oil. The inner friction plates 17 and the outer friction plates 19 are configured to be cooled by the circulating oil filling the internal space S.

Note that since the connection shaft 13 is sealed from the partition wall 27 an oil seal 52, the circulating oil that is discharged to the external space M does not leak to the outside of the case, and the oil is supplied to the cancel oil chamber 44 through the oil passage “d” and an oil passage “h.”

[Configuration of Communication Mechanism]

A communication mechanism that is configured to allow the inside of the clutch housing 20 to communicate with the outside of the clutch housing 20 will be described below.

As shown in FIG. 2, an end 39b₁ radially outward of the front wall portion 39b of the clutch housing 20 is a thick portion having a larger thickness than a portion radially inward of the front wall portion 39b. A plurality of communication holes 73, which allow the internal space S of the clutch housing 20 to communicate with the external space M of the clutch housing 20, are provided in the thick portion at predetermined intervals in the circumferential direction.

A ball valve 70, which selectively allows the inside of the clutch housing 20 to communicate with the outside of the clutch housing 20 based on a centrifugal force, is attached to each of the plurality of communication holes 73. The ball valve 70 is formed by a check ball 71 that closes the communication hole 73, and a case 72 accommodating the check ball 71.

That is, an end on the external space side of the case 72 has a tapered surface 72a tapered from the radial inner side toward the radial outer side of the clutch housing 20, and the ball valve 70 is configured to open and close as the check ball 71 moves along the tapered surface 72a according to the balance between the oil pressure and the centrifugal force, which are applied to the check ball 71.

Specifically, if a rotational speed rᵢₙ of the clutch housing 20 is lower than a preset predetermined rotational speed rₚᵣₑ, the centrifugal force applied to the check ball 71 is relatively small as compared to the centrifugal oil pressure applied from the circulating oil to the check ball 71. Accordingly, the check ball 71 moves toward the external space M along the tapered surface 72a to a cutoff position where the check ball 71 closes the communication hole 73.

If the rotational speed of the input shaft 15 reaches a rotational speed equal to or higher than the preset predetermined rotational speed rₚᵣₑ, the centrifugal force applied to the check ball 71 becomes relatively large as compared to the centrifugal oil pressure applied thereto. Accordingly, the check ball 71 withdraws toward the internal space S along the tilt of the tapered surface 72a to a withdrawn position where the check ball 71 allows the inside of the clutch housing 20 to communicate with the outside of the clutch housing 20 and allows the internal space S to be open to the atmosphere.

A communication mechanism 74, which selectively allows the inside of the clutch housing 20 to communicate with the outside of the clutch housing 20, is formed by the communication hole 73, the check ball 71, and the case 72. Note that the tapered surface 72a serving as a surface on which the check ball 71 of the ball valve 70 is seated may be formed in the communication hole 73, and the communication mechanism 74 need only have at least the communication hole 73 and the check ball 71 that closes the communication hole 73.

The rotational speed (the communication rotational speed) rₚᵣₑ for opening and closing the ball valve 70 can be arbitrarily set by the tilt of the tapered surface 72a, and is herein set so as to close the communication hole 73 while the clutch 16 is slipping, and to allow the inside of the clutch housing 20 to communicate with the outside of the clutch housing 20 while the clutch 16 is disengaged.

More specifically, in the present embodiment, the communication rotational speed rₚᵣₑ is set to a value close to an idling rotational speed of the engine 2 so as to cut off the communication between the inside and the outside of the clutch housing 20 when the vehicle is started by the engine 2 and when the vehicle runs at a low vehicle speed by the engine 2, during which the clutch 16 slips and rotates and generates a larger amount of heat, and so as to allow the internal space S of the clutch housing 20 to be open to the atmosphere in the cases other than the case where the vehicle is started by the engine 2 and the case where the vehicle runs at a low vehicle speed by the engine 2.

In other words, the communication mechanism 74 cuts off the communication between the internal space S and the external space M of the clutch housing 20 in the case of causing the clutch 16 to slip when starting the vehicle by the driving force of the engine 2. The communication mechanism 74 allows the internal space S of the clutch housing 20 to communicate with the external space M thereof in the case of rotating, with the clutch 16 being disengaged, the outer friction plates 19 at the predetermined rotational speed rₚᵣₑ or higher by driving rotation of the rotating electrical machine 3 when causing the vehicle to run by the rotating electrical machine 3.

The communication mechanism 74 provided in the clutch housing 20 need only be able to switch the communication between the internal space S and the external space M of the clutch housing 20 between the cutoff state in which the communication is cut off, and the communicating state in which the internal space S of the clutch housing 20 communicates with the external space M thereof, based on the rotating state of the clutch housing 20. As used herein, the “rotating state” refers to the state associated with rotation of the clutch housing 20, such as the rotational speed, acceleration, etc. of the clutch housing 20,

[Configuration of Control Valve]

The configuration of a portion of the control valve 22, which is associated with supply of the circulating oil to the oil supply portion A, will be described below.

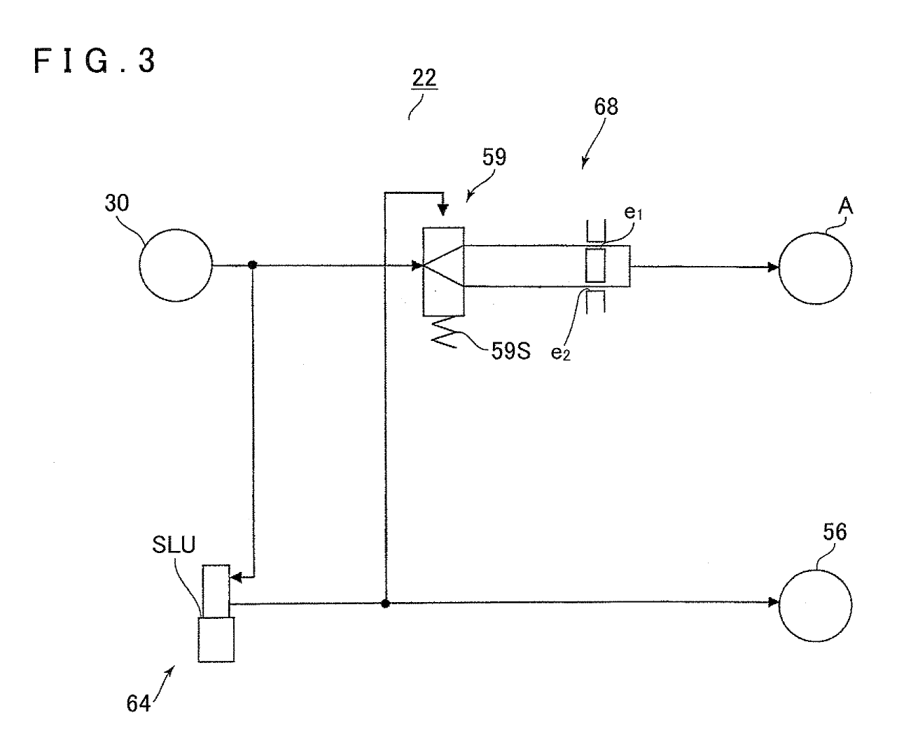

As shown in FIG. 3, the control valve 22 has a clutch control portion (a friction engagement device control portion) 64 that controls engagement and disengagement of the clutch 16, and a circulating-oil amount adjustment portion (an oil amount adjustment portion) 68 that is configured to be able to adjust the amount of circulating oil (the oil amount) to be supplied to the internal space S of the clutch housing 20, based on the control state of the clutch 16. The clutch control portion 64 controls an engagement pressure P to be supplied to the hydraulic servo 56 of the clutch 16, thereby controlling the clutch 16 to a disengaged state in which the friction plates 17, 19 are disengaged, a slipping state in which the friction plates 17, 19 slip and rotate, and a fully engaged state in which the friction plates 17, 19 are fully engaged.

Specifically, the clutch control portion 64 is formed by a linear solenoid valve SLU, which regulates the engagement pressure to be supplied to the hydraulic servo 56 of the clutch 16, based on an SLU command value that is output from the control portion 21 according to torque requested by the driver, and controls engagement and disengagement of the clutch 16.

Note that the “disengaged state in which the friction plates 17, 19 are disengaged” refers to the state in which the inner friction plates 17 are separated from the outer friction plates 19 and are not engaged with the outer friction plates 19. The “slipping state in which the friction plates 17, 19 slip and rotate” refers to a so-called half-clutch state. The “fully engaged state in which the friction plates 17, 19 are fully engaged” refers to the state in which the inner friction plates 17 and the outer friction plates 19 are fastened together without rotating relative to each other, and the clutch 16 is fully engaged, as opposed to the slipping state in which the friction plates 17, 19 slip and rotate.

On the other hand, the circulating-oil amount adjustment portion 68 is formed by a switch valve 59 that switches between oil passages e₁, e₂ that supply the circulating oil to the oil supply portion A. The circulating-oil amount adjustment portion 68 has a spool that communicates with/cuts off the oil passages e₁, e₂, a spring 59S that biases the spool to one side, and an oil chamber which is provided at an end located on the opposite side from the spring 59S and to which the engagement pressure of the clutch 16 regulated by the linear solenoid valve SLU is branched and input.

The switch valve 59 selectively switches between the first and second oil passages e₁, e₂, and the spring 59S biases the spool so as to cut off the first oil passage e₁, which has a large oil passage diameter and supplies a larger amount of circulating oil to the oil supply portion A as compared to the second oil passage e₂, and to communicate with the second oil passage e₂, which has a small oil passage diameter and supplies a smaller amount of circulating oil to the oil supply portion A as compared to the first oil passage e₁.

Thus, the spool operates according to the engagement pressure of the clutch 16 that is output from the linear solenoid valve SLU, and the switch valve 59 switches the amount of circulating oil to be supplied to the clutch housing 20. If the clutch 16 is disengaged and no control pressure is input from the linear solenoid valve SLU to the switch valve 59, the switch valve 59 communicates with the second oil passage e₂ that supplies a small amount of circulating oil, by the biasing force of the spring 59S. If the control pressure equal to or higher than a predetermined pressure is output from the linear solenoid valve SLU in order to engage the clutch 16, the switch valve 59 communicates with the first oil passage e₁ that supplies a large amount of circulating oil.

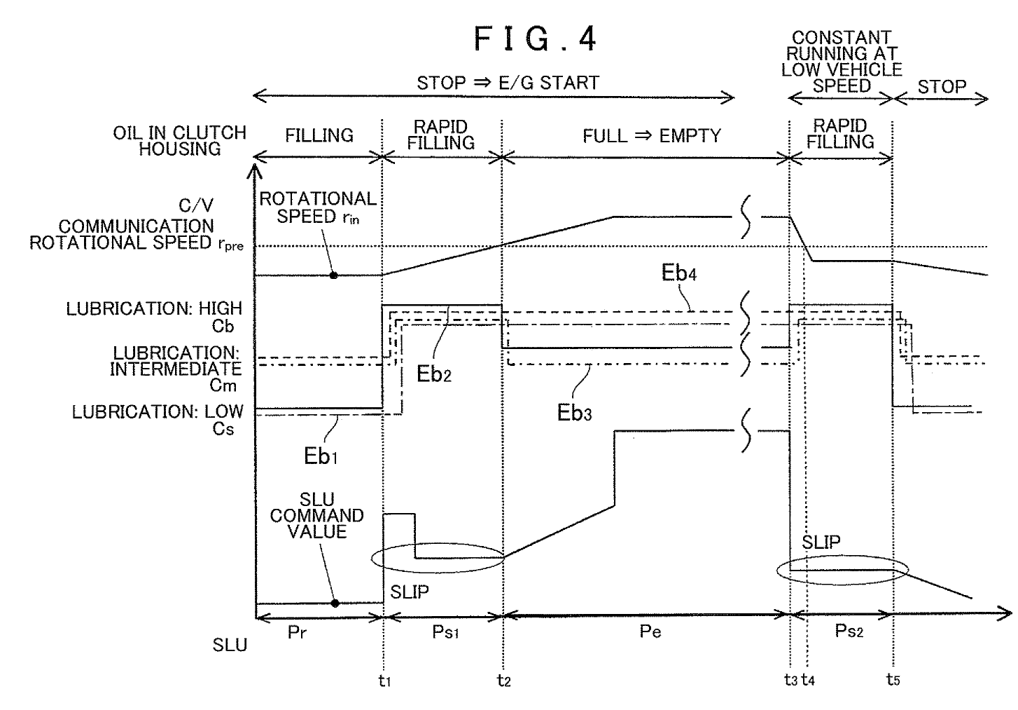

Operations of the embodiment of the present invention will be described with reference to FIG. 4.

For example, if the battery capacity is reduced, and in this state, the driver steps on an accelerator pedal in order to start the vehicle, the control portion 21 increases the command value of the linear solenoid valve SLU and starts the vehicle by the engine 2 while causing the inner friction plates 17 and the outer friction plates 19 of the clutch 16 to slip and rotate relative to each other so as not to cause shock (t₁ to t₂ in FIG. 4).

If the command value to the linear solenoid valve SLU is increased and the engagement pressure of the clutch 16 that is output from the linear solenoid valve SLU is increased, the supply oil passage of the circulating oil to the oil supply portion A is switched from the second oil passage e₂ to the first oil passage e₂ by the switch valve 59, and the amount of circulating oil to be supplied to the internal space S of the clutch housing 20 is increased.

That is, as shown by “Eb₁” in FIG. 4, if the clutch 16 changes from the disengaged state (a period Pr in FIG. 4) to the slipping state (a period Ps₁ in FIG. 4), the spool position of the switch valve 59 is switched, and the amount of circulating oil to be supplied to the internal space S of the clutch housing 20 changes from a first supply oil amount Cs to be supplied when the clutch 16 is disengaged, to a second supply oil amount Cb larger than the first supply oil amount Cs.

Moreover, in the case where the clutch 16 is in the half-clutch state, power from the engine 2 is not fully transmitted to the input shaft 15 of the transmission device 7. Thus, the rotational speed rᵢₙ of the clutch housing 20 drivingly coupled to the input shaft 15 of the transmission device 7 is lower than the communication rotational speed rₚᵣₑ of the ball valve 70 (rᵢₙ<rₚᵣₑ), and the communication between the inside and the outside of the clutch housing 20 is cut off by the ball valve 70.

Accordingly, even if the internal space S of the clutch housing 20 is filled with the circulating oil, a large amount of circulating oil is supplied to the internal space S, and the clutch 16 causes slip rotation of the friction plates 17, 19 while being cooled well with the circulating oil circulating at a high circulation speed.

If the SLU command value is increased, and the engagement pressure that is output from the linear solenoid valve SLU is increased, and thus the clutch 16 is fully engaged, and the friction plates 17, 19 do not slip and rotate (the fully engaged state Pe), the rotational speed rᵢₙ of the clutch housing 20 increases and becomes higher than the communication rotational speed rₚᵣₑ (rᵢₙ>rₚᵣₑ), and the ball valve 70 is brought into the communicating state (t₂ to t₃).

If the ball valve 70 is brought into the communicating state, the internal space S of the clutch housing 20 is open to the atmosphere, and the communication hole 73 of the clutch housing 20, which has been closed by the check ball 71 of the ball valve 70, is opened. Thus, the circulating oil in the internal space S is discharged through the communication hole 73, and air is introduced into the internal space S from the external space M of the clutch housing 20.

Accordingly, substantially the entire amount of circulating oil is discharged from the internal space S, and the internal space S of the clutch housing 20 becomes empty. The vehicle continues to run with the internal space S of the clutch housing 20 being empty.

Note that at this time, the switch valve 59 switches between the oil passages e₁, e₂ according to the engagement pressure of the clutch 16. Thus, the supply oil amount to the internal space S of the clutch housing 20 is still the second supply oil amount Cb.

On the other hand, if the vehicle is in a traffic jam, and the rotational speed rᵢₙ of the clutch housing 20 becomes lower than the value close to the idling rotational speed of the engine 2, the clutch 16 starts to slip again (t₃, Ps₂).

If the rotational speed rᵢₙ of the clutch housing 20 becomes lower than the communication rotational speed rₚᵣₑ (rᵢₙ<rₚᵣₑ), the ball valve 70 that has been open is closed, and the clutch housing 20 is sealed (t₄).

At this time, the supply oil amount to the internal space S of the clutch housing 20 is still the second supply oil amount Cb, the circulating oil is supplied from the oil supply portion A to the empty internal space S by the second supply oil amount Cb at a high flow rate. Thus, the internal space S is rapidly filled with the circulating oil into an oil-tight state (t₄ to t₅).

On the other hand, if the vehicle is switched to the EV running mode and starts to run only by the rotating electrical machine 3 without using the engine 2, the clutch 16 is disengaged, and thus the control pressure from the linear solenoid valve SLU is not input to the circulating-oil amount adjustment valve 59, and the supply oil passage of the circulating oil to the oil supply portion A is switched from the first oil passage e₁ to the second oil passage e₂, and the amount of circulating oil to be supplied to the internal space S of the clutch housing 20 is reduced.

That is, if the clutch 16 is switched from the slipping state Ps₁, Ps₂ or the fully engaged state Pe to the disengaged state Pr, the spool position of the switch valve 59 is switched, and the amount of circulating oil to be supplied to the internal space S of the clutch housing 20 is reduced from the second supply oil amount Cb to the first supply oil amount Cs.

If the rotational speed rᵢₙ of the clutch housing 20 becomes higher than the communication rotational speed rₚᵣₑ (rᵢₙ>rₚᵣₑ), the ball valve 70 is brought into the communicating state, and the communication hole 73 of the clutch housing 20, which has been closed by the check ball 71 of the ball valve 70, is opened.

Thus, the circulating oil in the internal space S is discharged through the communication hole 73, and air is introduced from the external space M into the internal space S of the clutch housing 20, whereby the internal space S of the clutch housing 20 becomes empty.

Since the hybrid drive apparatus 5 is configured as described above, the filling state of the clutch housing 20 with the oil can be switched according to the situation by the ball valve 70. That is, in the case where the clutch 16 transmits power of the engine 2 while slipping and rotating, such as when the vehicle is started by the engine 2, when the vehicle runs in a traffic jam, etc, the clutch 16 generates a large amount of heat. Thus, the ball valve 70 is closed to fill the internal space S of the clutch housing 20 with the oil, whereby the capability of cooling the clutch 16 can be increased.

In the case where the clutch 16 is disengaged such as during EV running, and the rotational speed of the clutch housing 20 is equal to or higher than the communication rotational speed of the ball valve 70, the ball valve 70 is released, and the circulating oil in the clutch housing 20 is discharged, whereby the internal space S becomes empty. Thus, stirring resistance of the circulating oil based on relative rotation between the inner friction plates 17 of the clutch 16 and the clutch housing 20 is eliminated, and energy efficiency of the hybrid drive apparatus 5 can be improved.

Moreover, even if the clutch 16 is engaged, the circulating oil in the internal space S of the clutch housing 20 can be discharged if the rotational speed rᵢₙ of the clutch housing 20 is higher than the communication rotational speed rₚᵣₑ of the ball valve 70. Thus, in this case, the weight (inertia) in the clutch housing 20 is reduced, and the driving force that rotates the unit of the clutch housing 20 can be reduced, whereby the energy efficiency of the hybrid drive apparatus 5 can be improved.

Since the ball valve 70 is provided radially outward of the front wall portion 39b of the clutch housing 20, the entire amount of circulating oil in the internal space S of the clutch housing 20 can be discharged, and the resistance due to stirring of the circulating oil as described above can be eliminated.

Moreover, the ball valve 70 is switched between the cut off state and the communication state based on the rotational speed of the clutch housing 20, whereby the filling state of the clutch housing 20 with the circulating oil can be automatically switched between the case where the vehicle runs at a low speed, in which, in many situations, the clutch 16 transmits power while slipping and thus generates a larger amount of heat, such as when the vehicle is started by the engine 2, and the case where the vehicle runs in the EV running mode, in which the vehicle often runs at a certain speed or higher.

Since the communication state between the inside and the outside of the clutch housing 20 is controlled by the ball valve 70 that opens and closes based on the centrifugal force, the communication mechanism, which is capable of allowing the inside of the clutch housing 20 to communicate with the outside thereof, can be formed by a simple configuration.

Moreover, the clutch 16 is controlled to the disengaged state, the slipping state, and the fully engaged state by controlling the engagement pressure that is regulated by the linear solenoid valve SLU, and the supply oil amount to be supplied to the internal space S of the clutch housing 20 can be adjusted based on the state of the clutch 16. Thus, a large amount of circulating oil can be supplied to the clutch housing 20 when the clutch 16 slips and rotates, and generates a large amount of heat.

In particular, if the internal space S of the clutch housing 20 is empty, the circulating oil is supplied to the internal space S of the clutch housing 20 by the second supply oil amount Cb at the high flow rate, and thus the internal space S can be rapidly filled with the circulating oil.

Moreover, when the clutch 16 is in the disengaged state, the oil amount to be supplied to the clutch housing 20 is adjusted to the first supply oil amount Cs at a low flow rate. This can reduce excessive oil consumption, and can contribute to reduction in stirring resistance of the clutch 16 described above.

Since the switch valve 59 is formed by a valve that operates according to the engagement pressure of the clutch 16, the oil amount to be supplied to the internal space S of the clutch housing 20 can be adjusted by a simple configuration.

### Second Embodiment

A second embodiment of the present invention will be described below. Note that the second embodiment is configured so that the oil amount to be supplied to the internal space S of the clutch housing 20 can be changed to three stages, as opposed to the first embodiment. Description of the configurations similar to those of the first embodiment is omitted, and such configurations are denoted with like reference characters.

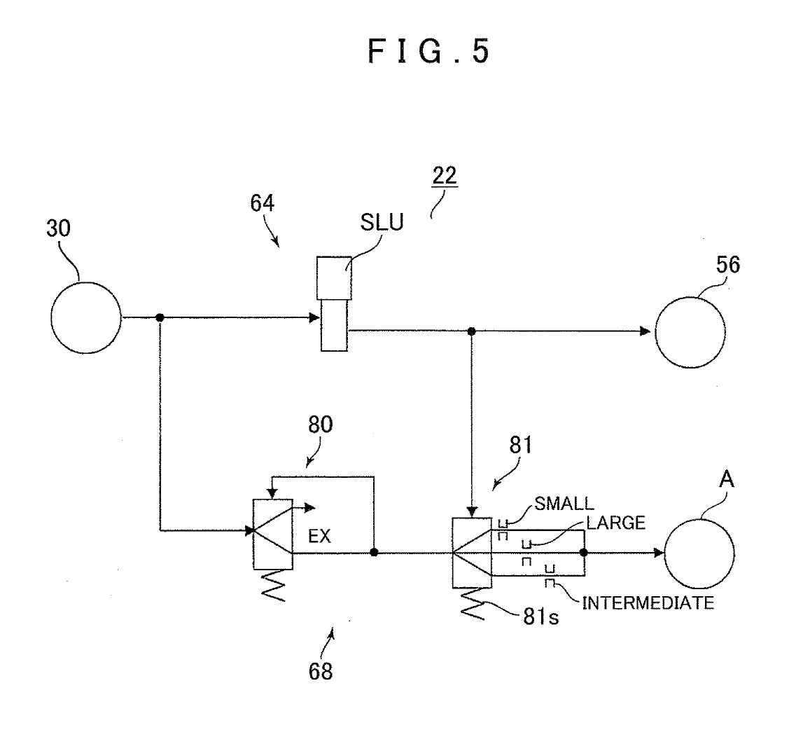

As shown in FIG. 5, the circulating-oil amount adjustment portion (the oil amount adjustment portion) 68 is formed by a modulator valve 80 that regulates an original pressure received from the oil pump device 30 to a predetermined pressure, and a switch valve 81 to which the certain oil pressure regulated by the modulator valve 80 is input, and which switches the oil amount to be supplied to the internal space S of the clutch housing 20.

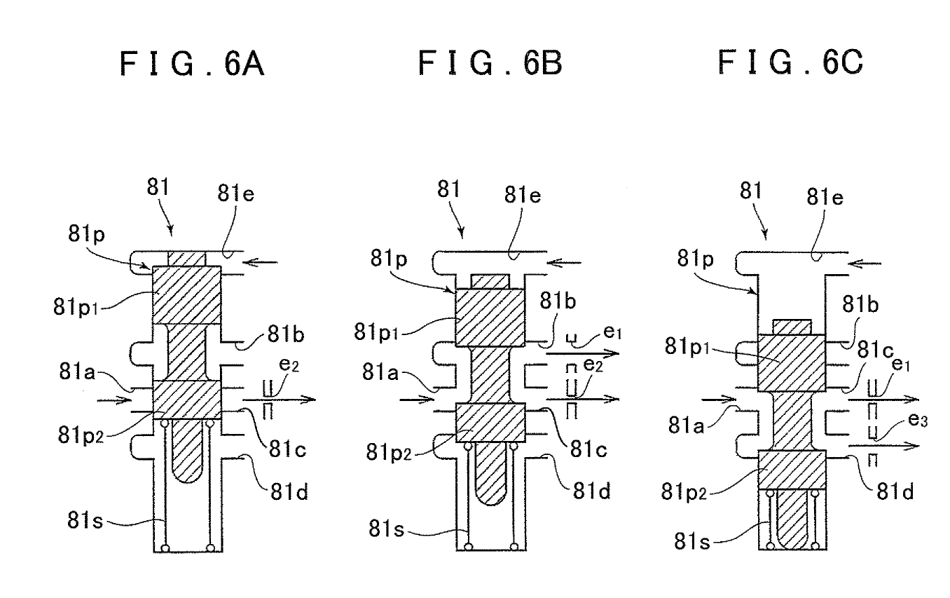

As show in FIG. 6, the switch valve 81 is configured to have a spool 81p, a spring 81s that biases the spool 81p upward in FIG. 6, an oil chamber 81e provided at an end located on the opposite side from the spring 81s, an input port 81a to which the oil pressure is input from the modulator valve 80, and output ports 81b, 81c, 81d, and the engagement pressure of the clutch 16 that is output from the linear solenoid valve SLU is input to the oil chamber 81e.

The output port 81b is connected to a first oil passage e₁ provided in an orifice having a large diameter (oil passage diameter) and, the output port 81c is connected to a second oil passage e₂ provided in an orifice having a small diameter (oil passage diameter) and, and the output port 81d is connected to a third oil passage e₃ provided in an orifice having an intermediate diameter between the orifice diameter of the first oil passage and the orifice diameter of the second oil passage (oil passage diameter).

Thus, if the clutch 16 is disengaged, and the engagement pressure that is input to the oil chamber 81e is low, the spool 81p is biased upward by the spring 81s as shown in FIG. 6A, and a second land portion 81p₂ of the spool 81p is located so as to cut off the output port 81c (a first position).

The output port 81c forms a greater groove than the second land portion 81p₂ of the spool 81p. Thus, at this time, the input port 81a communicates with the second oil passage e₂ having the small oil passage diameter, and the circulating oil in the first supply oil amount Cs is supplied through the second oil passage e₂ to the oil supply portion A.

On the other hand, as shown in FIG. 6B, if the clutch 16 is in the slipping state, and the engagement pressure for slip control of the clutch 16 is input to the oil chamber 81e, the spool 81p moves, and the input port 81a communicates with the output port 81b and the output port 81c (a second position). Thus, the circulating oil in the second supply oil amount Cb is supplied to the oil supply portion A through the first oil passage e₁ having the large oil passage diameter and the second oil passage e₂.

As shown in FIG. 6C, if the clutch 16 is in the fully engaged state, and the engagement pressure higher than that in the slipping state is input to the oil chamber 81e, the spool 81p moves, and the input port 81a communicates with the output port 81d and the output port 81c (a third position). Thus, the circulating oil in a third supply oil amount Cm smaller than the second supply oil amount Cb and larger than the first supply oil amount Cs is supplied to the oil supply portion A through the third oil passage e₃ having the intermediate oil passage diameter and the first oil passage e₁.

That is, the circulating-oil amount adjustment portion 68 is configured so that the amount of circulating oil to be supplied to the internal space S of the clutch housing 20 can be switched to three stages, namely the first supply oil amount Cs that is a small supply oil amount, and the second supply oil amount Cb that is a large supply oil amount, and the third supply oil amount Cm that is an intermediate supply oil amount (Cs<Cm<Cb).

As described above, the amount of circulating oil to be supplied to the internal space S of the clutch housing 20 can be switched to three stages and supplied. Therefore, as shown by “Eb₂” in FIG. 4, if the clutch 16 is disengaged (the clutch disengaged state Pr), the spool 81p of the switch valve 81 is located at the first position (the position of FIG. 6A), and the minimal amount of circulating oil, that is large enough for lubrication of bearings etc., is supplied to the internal space S of the clutch housing 20 by the first supply oil amount Cs.

If the clutch 16 starts to slip and rotate (the slipping state Ps₁), the spool 81p of the switch valve 81 is located at the second position (the position of FIG. 6B), and a large amount of circulating oil is supplied to the internal space S of the clutch housing 20 by the second supply oil amount Cb.

Moreover, if engagement of the clutch 16 proceeds and the clutch 16 is fully engaged (the fully engaged state Pe), the spool 81p of the switch valve 81 is located at the third position (the position of FIG. 6C), and a certain amount of circulating oil is supplied to the internal space S of the clutch housing 20 by the third supply oil amount Cm.

On the other hand, if the vehicle speed decreases during running of the vehicle due to a traffic jam etc., and the clutch 16 starts to slip (the slipping state Ps₂), the spool 81p of the switch valve 81 is located at the second position, and a large amount of circulating oil is supplied to the internal space S of the clutch housing 20 by the second supply oil amount Cb.

Thus, if the clutch 16 is in the slipping state Ps₁, Ps₂ in which the clutch 16 generates a large amount of heat, the clutch 16 is effectively cooled by the large amount of circulating oil that is supplied to the internal space S of the clutch housing 20 by the second supply oil amount Cb. In the disengaged state in which the clutch 16 is disengaged, the amount of circulating oil to be supplied can be adjusted to the first supply oil amount Cs to reduce the stirring resistance based on stirring of the circulating oil by the friction plates 17, 19.

Moreover, as the clutch 16 is fully engaged and the amount of heat generated by the clutch 16 is reduced, the oil amount to be supplied to the internal space S of the clutch housing 20 is reduced from the second supply oil amount Cb to the third supply oil amount Cm. This can suppress oil consumption, and can improve energy efficiency of the vehicle.

Since the first supply oil amount Cs that is supplied when the clutch 16 is in the disengaged state is made smaller than the third supply oil amount Cm that is supplied when the clutch 16 is in the fully engaged state, the amount of circulating oil contained in the internal space S of the clutch housing 20 at the time the clutch 16 is in the disengaged state is reduced as much as possible, and the stirring resistance due to stirring of the circulating oil in the internal space S by the friction plates 17, 19 is reduced as much as possible, whereby the drag torque can be reduced.

Note that as shown by “Eb₃” in FIG. 4, the oil amount to be supplied when the clutch 16 is in the disengaged state may be set to the third supply oil amount Cm, and as shown by “Eb₄” in FIG. 4, the oil amount to be supplied when the clutch 16 is in the fully engaged state may be set to the second supply oil amount Cb.

### Third Embodiment

A third embodiment of the present invention will be described below. The third embodiment is configured so that the switch valve 81 of the second embodiment is capable of being switched by a control linear solenoid valve 90, and description of configurations similar to those of the first and second embodiments is omitted, and such configurations are denoted with like reference numerals.

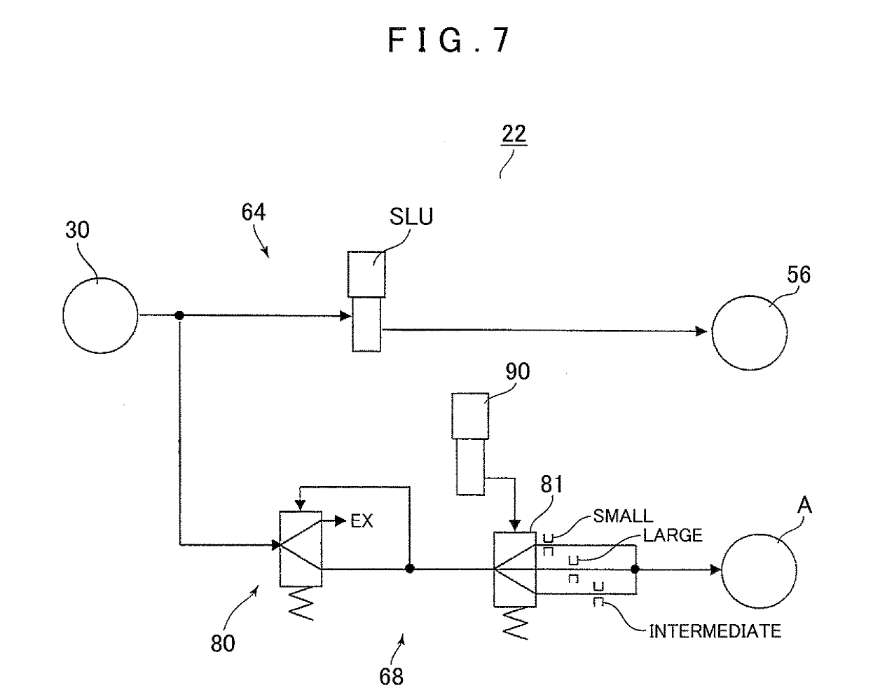

As shown in FIG. 7, the circulating-oil amount adjustment portion (the oil amount adjustment portion) 68 has, in addition to the modulator valve 80 and the switch valve 81, the control linear solenoid valve 90 that outputs a control pressure to the oil chamber 81e of the switch valve 81. The position of the spool 81p of the switch valve 81 is capable of being switched by controlling by the control portion 21 the control pressure to be output from the control linear solenoid valve 90.

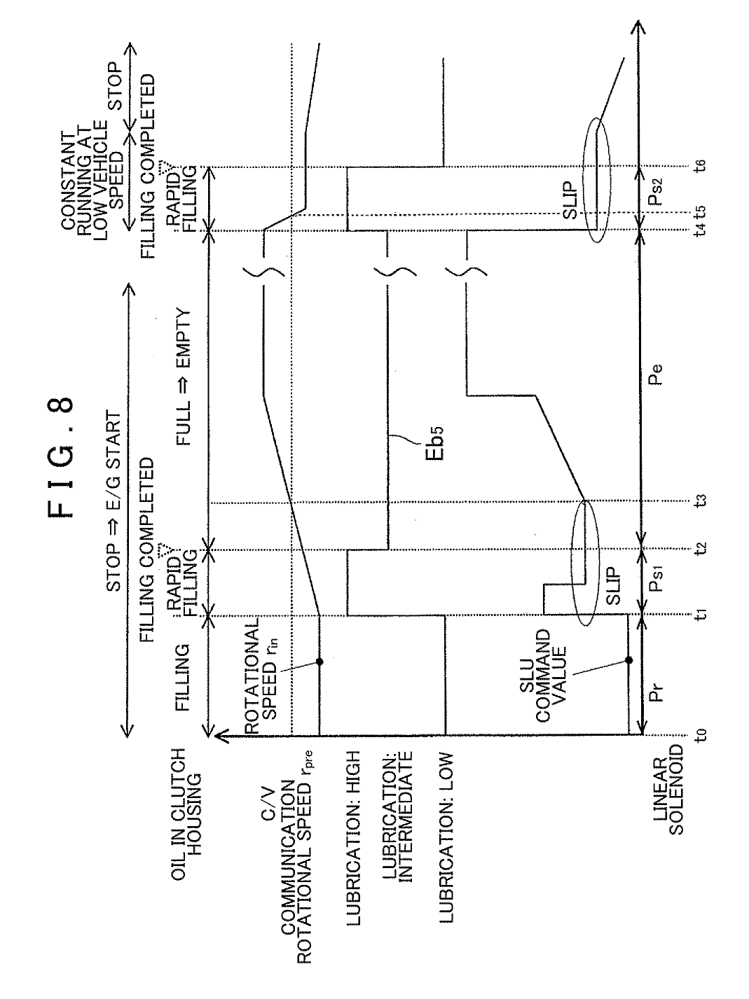

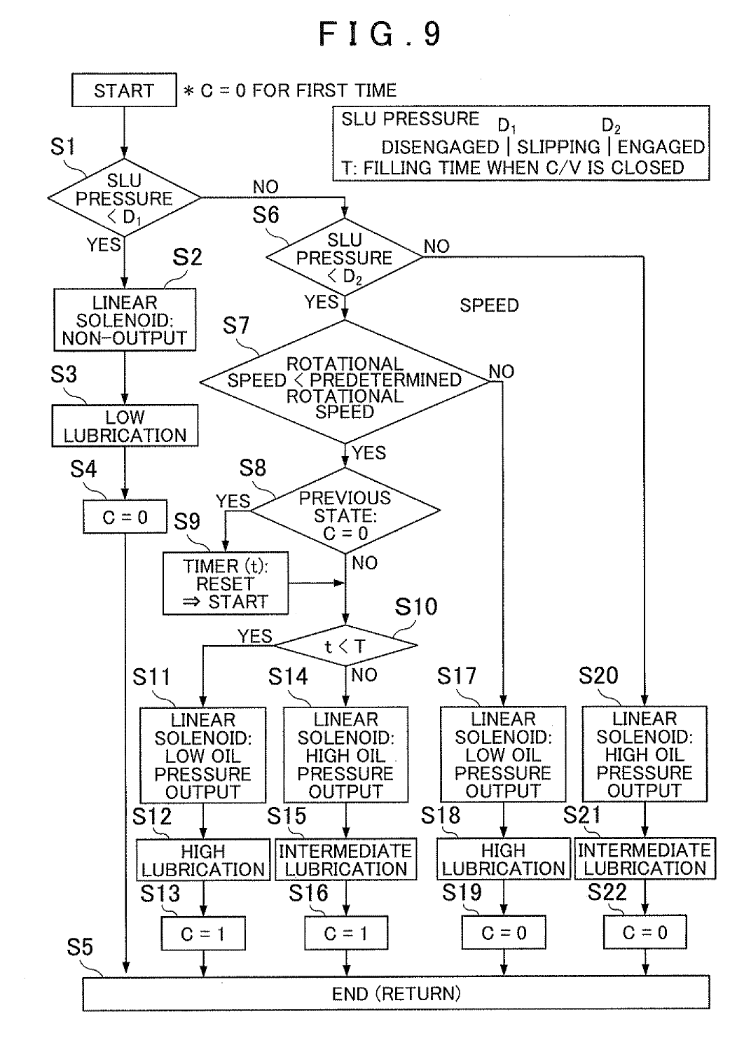

Thus, as shown in FIGS. 8 and 9, the control linear solenoid valve 90 is switched to a non-output state (S1, S2 in FIG. 9) in the case where the clutch 16 is disengaged, and the engagement pressure of the clutch 16 that is output from the linear solenoid valve SLU is lower than a first boundary pressure D₁ that switches the clutch 16 from the disengaged state Pr to the slipping state Ps₁, Ps₂ (S1, S2 in FIG. 9).

If the control linear solenoid valve 90 is switched to the non-output state, the spool 81p of the switch valve 81 is moved to the first position by the biasing force of the spring 81s, and the minimal amount of circulating oil, that is large enough for lubrication of bearings etc., is supplied to the internal space S of the clutch housing 20 by the first supply oil amount Cs (t₀ to t₁ in FIGS. 8, S3 to S5).

If the engagement pressure of the clutch 16 that is output from the linear solenoid valve SLU becomes higher than the first boundary pressure D₁ and lower than a second boundary pressure D₂, at which the friction plates 17, 19 of the clutch 16 do not rotate relative to each other, and the clutch 16 starts to slip (t₁, S6), the control portion 21 determines whether or not the rotational speed rᵢₙ of the clutch housing 20 is equal to or lower than the communication rotational speed rₚᵣₑ of the ball valve 70 (S7), and also determines whether or not a timer “t” has not been set (S8). If the timer “t” has not been set, the timer “t” is set.

The timer “t” is set to a predetermined time T it takes to fill the empty internal space S of the clutch housing 20 with the circulating oil when the circulating oil is supplied in the second supply oil amount Cb. During the predetermined time T (t<T), the control linear solenoid valve 90 outputs the control pressure so that the spool 81p of the switch valve 81 is located at the second position, and supplies the circulating oil in the second supply oil amount Cb to the internal space S of the clutch housing 20 (t₁ to t₂, S10 to S13).

After the predetermined time T has elapsed, the control linear solenoid valve 90 outputs the control pressure so that the spool 81p is located at the third position, according to a command from the control portion 21, and adjusts the supply amount of circulating oil to the third supply oil amount Cm (t₂ to t₃, S10 to S16).

On the other hand, if the rotational speed rᵢₙ of the clutch housing 20 becomes higher than the communication rotational speed rₚᵣₑ of the ball valve 70 when the clutch 16 is in the slipping state (57), the clutch 16 generates a larger amount of heat, and a larger amount of circulating oil is required. Thus, the supply oil amount to the internal space S of the clutch housing 20 is maintained at the second supply oil amount Cb (S17 to S19).

If the engagement pressure of the clutch 16 from the linear solenoid valve SLU becomes higher than the second boundary pressure D₂, and the clutch 16 is fully engaged, the control linear solenoid valve 90 controls the control pressure so that the spool 81p of the switch valve 81 is located at the third position, according to an electrical command from the control portion 21, and sets the amount of circulating oil to be supplied to the internal space S of the clutch housing 20 to the third supply oil amount Cm (t₂ to t₃, S20 to S22).

Thus, even if the clutch 16 is in the slipping state, the amount of circulating oil to be supplied to the internal space S of the clutch housing 20 is reduced when the internal space S is filled with the circulating oil. That is, the circulating oil is supplied to the internal space S of the clutch housing 20 in the second supply oil amount Cb only when the clutch 16 starts to slip. This can reduce consumption of the circulating oil while ensuring capability of cooling the clutch 16.

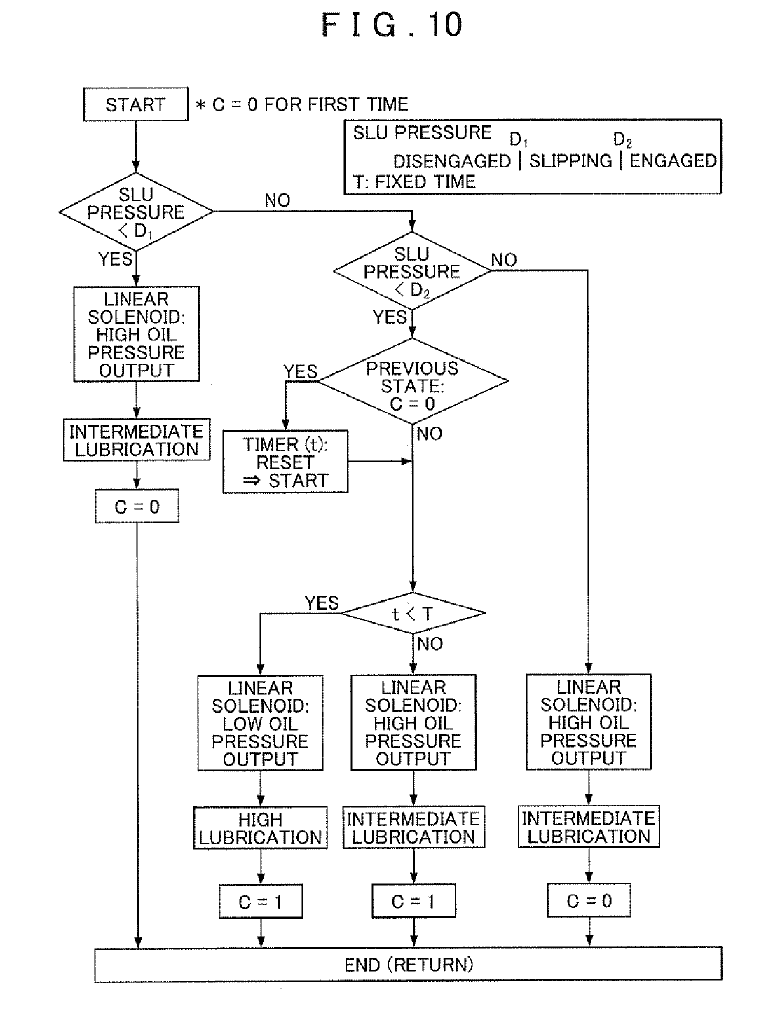

Note that in the above embodiment, the amount of circulating oil to be supplied to the internal space S of the clutch housing 20 is switched according to whether the rotational speed rᵢₙ of the clutch housing 20 is higher than the communication rotational speed rₚᵣₑ of the ball valve 70 or not. However, as shown in FIG. 10, such determination based on the rotational speed rᵢₙ of the clutch housing 20 need not necessarily be made. The supply oil amount may be set to the second supply oil amount Cb only in the initial period of the slipping of the clutch 16, and may be set to the third supply oil amount Cm after the predetermined time T of the timer “t” has elapsed.

The supply oil amount in the state in which the clutch 16 is disengaged may be set to the third supply oil amount Cm, and may be set to the first supply oil amount Cs when the clutch 16 is in the fully engaged state and after the predetermined time T of the timer “t” has elapsed. That is, the first supply oil amount may be equal to the third supply oil amount.

Note that the communication mechanism is formed by the ball valve 70 in the present embedment. In addition to an oil passage for circulating the circulating oil, the communication mechanism may have any configuration as long as the communication mechanism discharges the circulating oil contained in the internal space S of the clutch housing 20. For example, the communication mechanism may be formed by a ball valve that biases a check ball toward a tapered surface by a spring. Note that in the case of using this ball valve, the ball valve is attached to the annular portion 39c of the clutch housing 20 so that the tapered surface faces radially inward.

In addition to the ball valve described above, the communication mechanism may be configured to close the communication hole 73 according to the operation of the piston 40 of the clutch 16, or may have a configuration of a shutter type etc. For example, the rotational speed and acceleration of a rotating element of the transmission path on the wheel 6 side are detected, and a part of the configuration of the communication mechanism is provided on the motor hosing 26 side rather than on the clutch housing 20 side, so that the internal space S of the clutch housing 20 may be allowed to communicate with the external space M thereof or the communication therebetween may be cut off from the motor housing 26 side, based on the rotating state of the clutch housing 20 such as the detected rotational speed and acceleration.

Moreover, opening and closing of the communication mechanism may be electrically controlled, so that the communication mechanism is closed in the case where great cooling capability is required depending on the situation, and is opened in the cases other than the case where such great cooling capability is required.

The ball valve 70 need only be located at least radially outward with respect to inner peripheral surfaces (ends radially inward) 1 of the outer friction plates 19 in the clutch housing 20, and need only be able to reduce even slightly an increase in drag torque due to stirring of the circulating oil by the friction plates 17, 19.

Moreover, the ball valve 70 may be provided in the rear wall portion 37b of the clutch housing 20, and any number of ball valves 70 may be provided.

The inner friction plates 17 need only spline engage with (be drivingly coupled to) one of a rotating element on the transmission path L₁ on the engine side, such as the clutch hub 35, and a rotating element on the transmission path L₂ on the wheel side, such as the clutch drum 36. The outer friction plates 19 need only spline engage with (be drivingly coupled to) the other one of the rotating element on the transmission path L₁ on the engine side and the rotating element on the transmission path L₂ on the wheel side. The clutch 16 may be formed by a single-plate clutch.

Moreover, although the clutch 16 is used as a friction engagement element in the present embodiment, a brake may be used instead of the clutch. Note that the “clutch” is an element that transmits power between two rotating elements having a rotation difference therebetween while causing friction plates to slip and rotate, and thus transmits power while absorbing the differential rotation between the rotating elements. The “brake” is an element in which one friction plate is attached to a fixed member in order to latch rotation of a rotating element.

The transmission device 7 may be any speed change mechanism, and may be formed by, e.g., a multi-stage automatic transmission or a transmission device such as a CVT. The transmission device 7 may have a rotating electrical machine mounted on the transmission device 7 itself.

Moreover, the rotating electrical machine 3 and the clutch 16 need only be drivingly coupled to a rotating element of the transmission device 7, and can be drivingly coupled to, e.g., the input shaft or an output shaft of the transmission device 7.

Opening and closing of the communication mechanism may be actively controlled by controlling the rotational speed of the input shaft 15 by the transmission device 7. For example, in the case where the engine 2 is restarted by driving of the rotating electrical machine 3, the rotational speed of the input shaft 15 may be controlled to less than the communication rotational speed by the transmission device 7.

Moreover, the present invention may be applied not only to FF type hybrid cars but also FR type hybrid cars, and may be applied to any vehicle as long as the vehicle has an engine and a rotating electrical machine as driving sources.

It should be understood that the inventions described in the above embodiments may be used in any combination.

The hydraulic control device according to the present invention is used in hybrid drive apparatuses that are preferably used in vehicles such as passenger cars, buses, and trucks, and that has a friction engagement device provided on a transmission path between an engine and wheels.

What is claimed is:

1. A hybrid drive apparatus, comprising:
a friction engagement device placed on a transmission path between an engine and a wheel and having a first friction plate drivingly coupled to a transmission path on an engine side in the transmission path and a second friction plate drivingly coupled to a transmission path on a wheel side, a rotating electrical machine drivingly coupled to the transmission path on the wheel side;
a case member having an internal space that accommodates the first and second friction plates of the friction engagement device and that is configured so that the first and second friction plates can be soaked with oil;
a communication mechanism that is capable of allowing or cutting off the communication between the internal space of the case member and outside, and that discharges the oil from the internal space to the outside when the internal space communicates with the outside;
a friction engagement device control portion in which the friction engagement device is capable of controlling an engagement pressure to obtain a disengaged state in which the first and second friction plates are disengaged and a slipping state in which the first and second friction plates slip and rotate; and
an oil amount adjustment portion that is configured to be able to adjust an oil amount to be supplied to the internal space of the case member, based on a control state of the friction engagement device, and that adjusts the oil amount to a first supply oil amount when the friction engagement device is disengaged, and adjusts the oil amount to a second supply oil amount larger than the first supply oil amount when the friction engagement device starts to slip.

2. The hybrid drive apparatus according to claim 1, wherein
the friction engagement device control portion is capable of controlling the engagement pressure so as to obtain a fully engaged state in which the first and second friction plates are fully engaged, and
the oil amount adjustment portion adjusts the oil amount to a third supply oil amount smaller than the second supply oil amount, when the friction engagement device is in the fully engaged state.

3. The hybrid drive apparatus according to claim 2, wherein
the oil amount adjustment portion adjusts the first supply oil amount so that the first supply oil amount is smaller than the third supply oil amount.

4. The hybrid drive apparatus according to claim 2, wherein
the oil amount adjustment portion adjusts the oil amount to be supplied to the case member to the first or third supply oil amount after a predetermined time it takes to fill the empty internal space of the case member with the oil when the oil is supplied in the second supply oil amount, elapses since the friction engagement device has started to slip.

5. The hybrid drive apparatus according to claim 3, wherein
the oil amount adjustment portion adjusts the oil amount to be supplied to the case member to the first or third supply oil amount after a predetermined time it takes to fill the empty internal space of the case member with the oil when the oil is supplied in the second supply oil amount, elapses since the friction engagement device has started to slip.

6. The hybrid drive apparatus according to claim 1, wherein
the oil amount adjustment portion has a switch valve in which a spool operates based on the engagement pressure of the friction engagement device that is output from the friction engagement device control portion, and the switch valve switches the oil amount to be supplied to the case member.
